(19) United States
(12) Patent Application Publication
(10) Pub. No.: US 2026/0164515 A1
(43) Pub. Date: Jun. 11, 2026

(54) INDUCTION ENERGY TRANSMISSION SYSTEM

(71) Applicant: BSH Hausgeräte GmbH, Munich (DE)

(72) Inventors: Jesus Manuel Moya Nogues, Zaragoza (ES); Sergio Llorente Gil, Zaragoza (ES); Emilio Plumed Velilla, Zaragoza (ES); Jorge Pascual Aza, Zaragoza (ES); Jorge Tesa Betes, Zaragoza (ES); Francisco Villuendas Lopez, Zaragoza (ES); Javier Serrano Trullen, Zaragoza (ES)

(21) Appl. No.: 18/716,538

(22) PCT Filed: Dec. 19, 2022
(86) PCT No.: PCT/EP2022/086817

§ 371 Date: Jun. 5, 2024

(30) Foreign Application Priority Data
Dec. 21, 2021 (EP) 21383183.7

(51) Int. Cl. H05B 6/12; H02J 50/10; H02J 50/90; H05B 6/06

(52) U.S. Cl. CPC H05B 6/1236; H02J 50/10; H02J 50/90; H05B 6/062

(57) ABSTRACT

An induction energy transmission system, in particular an induction cooking system, includes a supply unit having a supply induction element for inductively providing energy, a positioned unit having a receiving unit which includes a receiving induction element for receiving the inductively provided energy, and a control unit designed to control the supply unit by using a parameter set which includes a plurality of parameters and to receive at least one of the parameters of the parameter set from the positioned unit. The control unit is designed to determine a correction factor for at least one of the parameters of the parameter set.

The invention relates to an induction energy transmission system in accordance with the preamble of claim 1 and a method for operating an induction energy transmission system in accordance with the preamble of claim 15.

Induction energy transmission systems for the inductive transmission of energy from a primary coil of a supply unit to a secondary coil of a positioned unit are already known from the prior art. For example, induction hobs are known which are provided not only for the inductive heating of cookware but also for the inductive supply of energy to small household appliances. Control of the supply unit by a control unit is in this case based on a parameter set, wherein in the case of some known induction energy transmission systems at least one parameter of the parameter set, for example a self-inductance of the secondary coil, an energy requirement or a total electrical load, is transmitted wirelessly, for example by NFC, from the positioned unit to the control unit. The parameters of the parameter set, in particular the parameters relating to the positioned unit, are assumed to be constant in the case of induction energy transmission systems known hitherto and changes to these parameters occurring during operation have until now not been taken into account. This results in disadvantageously long response times during commissioning or during load changes, low efficiency in inductive energy transmission and the risk of potential damage to components, for example because of overvoltages due to parameters that are too imprecise, as a result of which operating comfort is reduced for users of induction energy transmission systems known hitherto.

The object of the invention consists in particular, but is not restricted to, the provision of a generic device with improved properties as regards operating comfort. The object is inventively achieved by the features of claims 1 and 15, while advantageous embodiments and developments of the invention can be found in the subclaims.

The invention is based on an induction energy transmission system, in particular an induction cooking system, with a supply unit which has at least one supply induction element for inductively providing energy, with a control unit for controlling the supply unit, and with at least one positioned unit which has at least one receiving unit with at least one receiving induction element for receiving the inductively provided energy, wherein the control unit is provided to use a parameter set to control the supply unit and to receive at least one parameter of the parameter set from the positioned unit.

It is proposed that the control unit is provided to determine at least one correction factor for at least one parameter of the parameter set.

Thanks to such a configuration, an induction energy transmission system with particularly high operating comfort can advantageously be provided. In particular, a response time can be optimized when adjusting a supply power inductively provided by the supply unit. Further, changes in an inductive coupling between the supply induction element of the supply unit and the receiving induction element can be reliably detected and taken into account in the control of the supply unit and particularly precise control can be enabled. Moreover, particularly efficient operation of the induction energy transmission system can advantageously be enabled. Additionally, safety can advantageously be increased. In particular, overvoltages and associated potential damage to components of the induction energy transmission system can be prevented.

The induction energy transmission system has at least one main functionality in the form of wireless energy transmission, in particular in a wireless supply of energy to positioned units. In an advantageous configuration the induction energy transmission system is embodied as an induction cooking system with at least one further main function differing from a purely cooking function, in particular at least one supply of energy and operation of small household appliances. For example, the induction energy transmission system could be embodied as an induction oven system and/or as an induction grill system. In particular, the supply unit could be embodied as part of an induction oven and/or as part of an induction grill. The induction energy transmission system embodied as an induction cooking system is preferably embodied as an induction hob system. The supply unit is then in particular embodied as part of an induction hob. In a further advantageous configuration the induction energy transmission system is embodied as a kitchen energy supply system and can be provided not only for a main function in the form of a supply of energy and operation of small household appliances but also for the provision of cooking functions.

A “supply unit” should be understood as a unit which in at least one operating mode inductively provides energy and which in particular has a main functionality in the form of energy provision. For the provision of energy the supply unit has at least one supply induction element which in particular has at least one coil, in particular at least one primary coil, and/or is embodied as a coil and which in particular in operating mode inductively provides energy. The supply unit could have at least two, in particular at least three, advantageously at least four, particularly advantageously at least five, preferably at least eight and particularly preferably multiple supply induction elements, which in operating mode could each inductively provide energy, and in particular to a single receiving induction element or to at least two or more receiving induction elements of at least one positioned unit and/or of at least one further positioned unit. At least some of the supply induction elements could be arranged in close proximity to one another, for example in a row and/or in the form of a matrix. The supply unit preferably has at least one compensation capacitor, which can be connected to the supply induction element electrically in parallel or electrically in series, and which in particular can be provided for reactive power compensation.

A “control unit” should be understood as an electronic unit which is provided to control and/or regulate at least the supply unit. The control unit comprises a computing unit and in particular in addition to the computing unit a memory unit with at least one control and/or regulation program stored therein, which is provided to be executed by the computing unit. The control unit has at least one inverter unit. The inverter unit preferably carries out a frequency conversion in operating mode and in particular converts an input-side low-frequency alternating voltage into an output-side high-frequency alternating voltage. The low-frequency alternating voltage preferably has a maximum frequency of 100 Hz. The high-frequency alternating voltage preferably has a minimum frequency of 1000 Hz. The inverter unit is preferably provided for the adjustment of the energy inductively provided by the at least one supply induction element by adjusting the high-frequency alternating voltage. The control unit preferably comprises at least one rectifier. The inverter unit has at least one inverter switching element. For operation of the at least one supply induction element the inverter switching element preferably generates an oscillating electric current, preferably with a frequency of at least 15 kHz, in particular of at least 17 kHz and advantageously of at least 20 kHz. The inverter unit preferably comprises at least two inverter switching elements, which are preferably embodied as bipolar transistors with an insulated gate electrode and particularly advantageously at least one damping capacitor.

A “positioned unit” should be understood as a unit which in at least one operating mode inductively receives energy and converts the inductively received energy at least partially into at least one further form of energy for the provision of at least one main function. For example, the energy inductively received by the positioned unit could in operating mode be converted, in particular directly, into at least one further form of energy, for example into heat. Alternatively or additionally, the positioned unit could have at least one electrical consumer, for example an electric motor or the like. The positioned unit has at least one receiving unit with a receiving induction element to receive the inductively provided energy. The receiving unit could for example have at least two, in particular at least three, advantageously at least four, particularly advantageously at least five, preferably at least eight and particularly preferably multiple receiving induction elements, which in particular in operating mode could each inductively receive energy, in particular from the supply induction element. The positioned unit could for example be embodied as an item of cookware. The cookware preferably has at least one food receiving space and converts the inductively received energy in operating mode at least partially into heat to heat food arranged in the food receiving space. The positioned unit embodied as cookware preferably has at least one further unit, for the provision of at least one further function, which goes beyond pure heating of food and/or differs from heating of food. For example, the further unit could be embodied as a temperature sensor or as a stirring unit or the like. Alternatively, the positioned unit could be embodied as a small household appliance. The small household appliance is preferably a location-independent household appliance, which has at least the receiving induction element and at least one functional unit, which in an operating mode provides at least one household appliance function. “Location-independent” should in this connection be understood to mean that the small household appliance can be positioned freely in a household by a user, and in particular without any aids, in particular in contrast to a large household appliance, which is permanently positioned and/or installed in a particular position in a household, such as for example an oven or a refrigerator. The small household appliance is preferably embodied as a small kitchen appliance and in operating mode provides at least one main function for processing food. The small household appliance could, without being restricted thereto, for example be embodied as a food processor and/or as a mixer and/or as a stirrer and/or as a grinder and/or as a kitchen scale or as a kettle or as a coffee machine or as a rice cooker or as a milk frother or as a deep fat fryer or as a toaster or as a juicer or as a slicer or the like.

The receiving induction element of the receiving unit comprises at least one secondary coil and/or is embodied as a secondary coil. In an operating mode of the positioned unit the receiving induction element supplies at least one consumer of the positioned unit with electrical energy. Additionally, it is conceivable for the positioned unit to have an energy store, in particular a battery, which is provided to store electrical energy received via the receiving induction element in a charging state and to provide it in a discharging state to supply the functional unit. The receiving unit preferably has at least one compensation capacitor which is connected to the receiving induction element electrically in parallel or electrically in series, and which in particular can be provided for reactive power compensation.

The induction energy transmission system preferably has at least one positioning plate to position the positioned unit. A “positioning plate” should be understood as at least one unit, in particular a plate-like unit, which is provided to position at least one positioned unit and/or to place at least one item to be cooked. The positioning plate could for example be embodied as a worktop, in particular as a kitchen worktop, or as a partial region of at least one worktop, in particular at least one kitchen worktop, in particular of the induction energy transmission system. Alternatively or additionally, the positioning plate could be embodied as a hob plate. The positioning plate embodied as a hob plate could in particular form at least part of a hob outer housing, and could form at least a large part of the hob outer housing, in particular together with at least one outer housing unit to which the positioning plate embodied as a hob plate could in particular be connected in at least one assembled state. The positioning plate is preferably made of a nonmetallic material. The positioning plate could for example be formed at least in the main of glass and/or of glass ceramic and/or of Neolith and/or of Dekton and/or of wood and/or of marble and/or of stone, in particular of natural stone, and/or of laminate and/or of plastic and/or of ceramic. In the present document, position designations such as for example “beneath” or “above” relate to an assembled state of the positioning plate, providing this is not explicitly described otherwise. In the assembled state the supply unit is preferably arranged beneath the positioning plate.

The induction energy transmission system preferably comprises a communication unit. The communication unit is preferably provided for bidirectional wireless data transmission, i.e. to both receive and transmit data wirelessly between the control unit and the positioned unit. The communication unit preferably has at least one communication element which is connected to the control unit and in particular is provided to receive and transmit data wirelessly. The communication unit preferably has at least one further communication element which is arranged inside the positioned unit and in particular is provided to receive and transmit data wirelessly. The communication unit could be provided for wireless data transmission between the positioned unit and the control unit by RFID, or by WIFI, or by Bluetooth or by ZigBee or for wireless data transmission in accordance with another suitable standard. The communication unit is preferably provided for wireless data transmission between the positioned unit and the control unit by NFC. The control unit is preferably provided to receive the at least one parameter of the parameter set wirelessly from the positioned unit, namely by means of the communication unit.

A “parameter set” should be understood as a plurality of at least two parameters which the control unit uses to control the supply and on the basis of which the control unit controls the energy inductively provided by the supply unit in accordance with the nature of the positioned unit and/or in accordance with a current operating mode of the positioned unit, which can in particular be selected by a user of the induction energy transmission system. The parameter set preferably comprises at least one constant constructive and/or geometric characteristic variable of the supply induction element and/or of the receiving induction element. Constructive and/or geometric characteristic variables can in this case, without being limited thereto, for example comprise a shape and/or size, in particular a radius and/or internal diameter and/or an external diameter, and/or a cross-sectional area and/or a number of windings and/or a material and/or a spatial position of the receiving induction element inside the positioned unit and/or could be a vertical distance of the supply induction element from the positioning plate and/or the like. At least one parameter of the operating parameter set preferably comprises an electrical characteristic variable, in particular changeable over time, of the supply induction element and/or of the receiving induction element, for example absolute values of electrical resistances and/or impedances in a primary circuit of the supply unit and/or in a secondary circuit of the receiving unit and/or inductances, in particular self-inductances, and/or magnetic flux densities of the supply induction element and/or of the receiving induction element and/or a resonance frequency and/or a material constant, for example a magnetic permeability of a magnetic flux bundling element of the supply unit and/or of the receiving unit. Further, at least one parameter of the operating parameter set can comprise at least one operating characteristic variable of the positioned unit, for example a maximum power and/or a minimum power and/or number of power levels and/or a number and/or type of operable electrical loads and/or a voltage and/or current intensity required in an operating mode.

The control unit can be provided to determine the correction factor arithmetically. It is also conceivable for the control unit to be provided to derive the correction factor from data stored inside the memory unit, for example stored measured data or the like. The control unit is preferably provided to determine multiple correction factors for different parameters of the parameter set, preferably for each parameter, changeable over time, of the parameter set.

In the present document, numerals such as “first” and “second” for example, which are placed in front of certain terms, serve only to distinguish between objects and/or to assign objects to one another and do not imply an existing total number and/or ranking of the objects. In particular, a “second object” does not necessarily imply the presence of a “first object”.

“Provided” should be understood as specifically programmed, designed and/or equipped. By saying that an object is provided for a particular function, it should be understood that the object fulfills and/or executes this particular function in at least one application mode and/or operating mode.

Further, it is proposed that to determine the correction factor the control unit is provided to determine at least one coupling factor between the receiving induction element and the supply induction element. As a result of this, a sufficiently precise determination of the correction factor can advantageously be achieved with simple technical means. The coupling factor describes a portion of a magnetic flux that can be shared by the supply induction element and the receiving induction element in operating mode and can assume values between 0 and 1, wherein a value of 1 describes an ideal magnetic coupling, which cannot be achieved in practice because of magnetic leakage fluxes. The control unit is preferably provided to determine the at least one coupling factor arithmetically, namely by means of the computing unit.

Moreover, it is proposed that to determine the correction factor the control unit is provided to use an equivalent impedance between the supply unit and the receiving unit. Such a configuration means that a particularly simple and reliable determination of the at least one coupling factor can advantageously be achieved. The equivalent impedance between the supply unit and the receiving unit describes a total impedance of an imaginary shared electrical circuit of the receiving unit and of the supply unit during an inductive energy transmission of the supply induction element to the receiving induction element. The control unit is preferably provided to measure the equivalent impedance in operating mode at a primary circuit comprising the supply induction element, wherein to this end the control unit can have corresponding measuring devices.

Furthermore it is proposed that the control unit is provided to determine an equivalent resistance from the real part of the equivalent impedance. As a result, a determination of the at least one coupling factor can advantageously be further improved. The equivalent resistance in this case describes the ohmic portions of the total impedance of the imaginary shared electrical circuit of the receiving unit and of the supply unit during an inductive energy transmission from the supply induction element to the receiving induction element.

Additionally, it is proposed that the control unit is provided to determine an equivalent inductance from the imaginary part of the equivalent impedance. As a result, a determination of the at least one coupling factor can advantageously be further improved. The equivalent inductance in this case describes the inductive portions of the total impedance of the imaginary shared electrical circuit of the receiving unit and of the supply unit during an inductive energy transmission from the supply induction element to the receiving induction element.

Moreover, it is proposed that the control unit is provided to determine a first coupling factor between the supply unit and the receiving unit from the equivalent resistance. As a result, a particularly simple and reliable determination of the first coupling factor can advantageously be enabled. Further, it is proposed that the control unit is provided to determine a second coupling factor between the supply unit and the receiving unit from the equivalent inductance. As a result, a particularly simple and reliable determination of the second coupling factor can advantageously be enabled. Additionally, it is proposed that the control unit is provided to determine the correction factor from a comparison between the first coupling factor and the second coupling factor. As a result, a particularly simple, fast and reliable determination of the at least one correction factor can advantageously be enabled.

In a further advantageous configuration it is proposed that the control unit is provided to use at least one transformer equation to calculate a coupling factor. Such a configuration means that an alternative or additional possibility for the determination of the at least one coupling factor can advantageously be enabled. The control unit is preferable provided, for the calculation of a coupling factor, to use at least one first transformer equation which comprises a primary side of an imaginary transformer comprising the supply induction element, and at least one second transformer equation which comprises the secondary side of the imaginary transformer comprising the receiving induction element.

Furthermore it is proposed that the control unit is provided to take into account, in the determination of the correction factor, a vertical distance between the supply induction element and the receiving induction element. As a result, a particularly precise determination of the correction factor and thus a particularly efficient and reliable operation can advantageously be enabled. The control unit can be provided to determine the vertical distance arithmetically. For example, a vertical distance between the supply induction element and the positioning plate could be stored in the memory unit and the positioned unit could transmit a vertical distance between the receiving induction element and a lower edge of the positioning plate to the control unit wirelessly by means of the communication unit, wherein the control unit could determine the vertical distance between the supply induction element and the receiving induction element by adding up the aforementioned distances. It is also conceivable for measured values to be stored in the memory unit, these containing a correlation between the at least one coupling factor and different vertical distances between the supply induction element and the receiving induction element, wherein the control unit can determine a current vertical distance between the supply induction element and the receiving induction element from the previously determined coupling factor. Additionally, the control unit can be provided to take into account a horizontal displacement between a geometric center point of the supply induction element and a geometric center point of the receiving induction element in the determination of the correction factor.

Moreover, it is proposed that the control unit is provided to take into account, in the determination of the correction factor, a magnetic permeability of a magnetic flux bundling element of the supply unit and/or receiving unit. As a result, an accuracy in the determination of the correction factor can advantageously be further improved. The magnetic permeability of the magnetic flux bundling element of the supply unit is preferably stored in the memory unit. The control unit is preferably provided to receive the magnetic permeability of the magnetic flux bundling element of the receiving unit wirelessly from the positioned unit.

Further, it is proposed that the parameter set comprises a self-inductance of the supply induction element. As a result, an important parameter of the parameter set for controlling the supply unit, which in an operating mode may be subject to strong fluctuations, can advantageously be taken into account and can be corrected by means of the correction factor. Thus a particularly efficient operation can advantageously be enabled. Moreover, it is proposed that the parameter set comprises a self-inductance of the receiving induction element. Such a configuration advantageously means that a further important parameter of the parameter set, which in an operating mode may likewise be subject to strong fluctuations, can advantageously be used in the control of the supply unit and can be corrected by means of the correction factor, as a result of which an efficiency can advantageously be further improved. Furthermore it is proposed that the parameter set comprises a mutual inductance between the supply induction element and the receiving induction element. If the parameter set comprises a mutual inductance between the supply induction element and the receiving induction element, an accuracy in the control of the supply unit can advantageously be improved and an efficiency in operation of the induction energy transmission system can be still further improved.

The invention is further based on a method for operating an induction energy transmission system, in particular in accordance with one of the configurations described above, with a supply unit which has at least one supply induction element for inductively providing energy, and with at least one positioned unit which has at least one receiving unit with at least one receiving induction element for receiving the inductively provided energy, wherein a parameter set is used to control the supply unit and at least one parameter of the parameter set is received from the positioned unit.

It is proposed that at least one correction factor is determined for at least one parameter of the parameter set. By means of such a method a particularly user-friendly, efficient and safe operation of the induction energy transmission system can advantageously be enabled.

The induction energy transmission system should here not be limited to the application and form of embodiment described above. In particular, the induction energy transmission system can have a number of individual elements, components and units that deviate from the number mentioned herein in order to fulfill a functionality described herein.

Further advantages emerge from the following description of the drawing. An exemplary embodiment of the invention is illustrated in the drawing. The drawing, the description and the claims contain numerous features in combination. The person skilled in the art will also expediently consider the features individually and combine them in meaningful further combinations.

In the drawing:

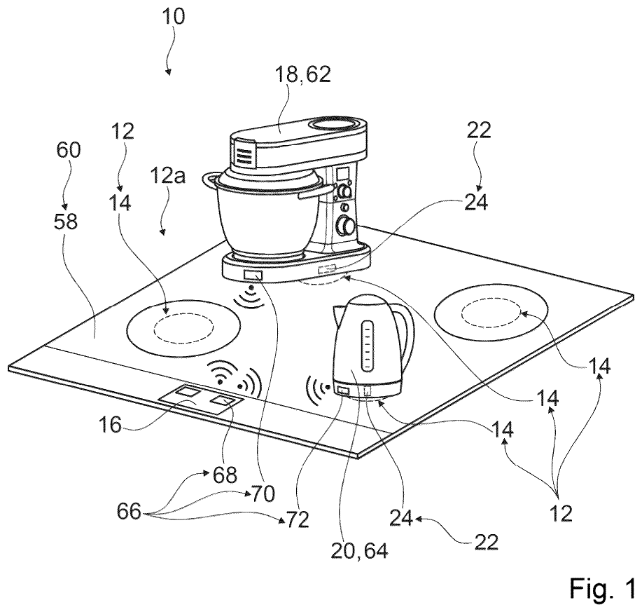

FIG. 1 shows an induction energy transmission system with a supply unit, a control unit for controlling the supply unit, a positioned unit and a further positioned unit, each of which comprises a receiving unit, in a schematic illustration,

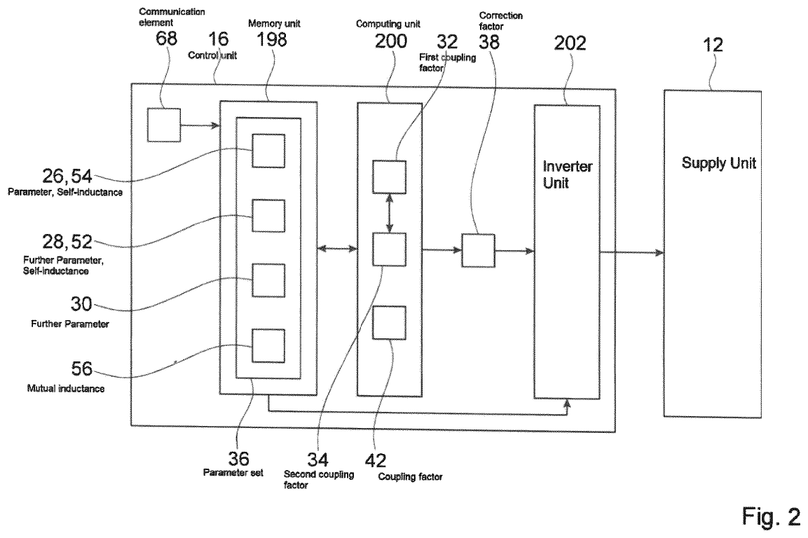

FIG. 2 shows a schematic block diagram to illustrate a functionality of the control unit,

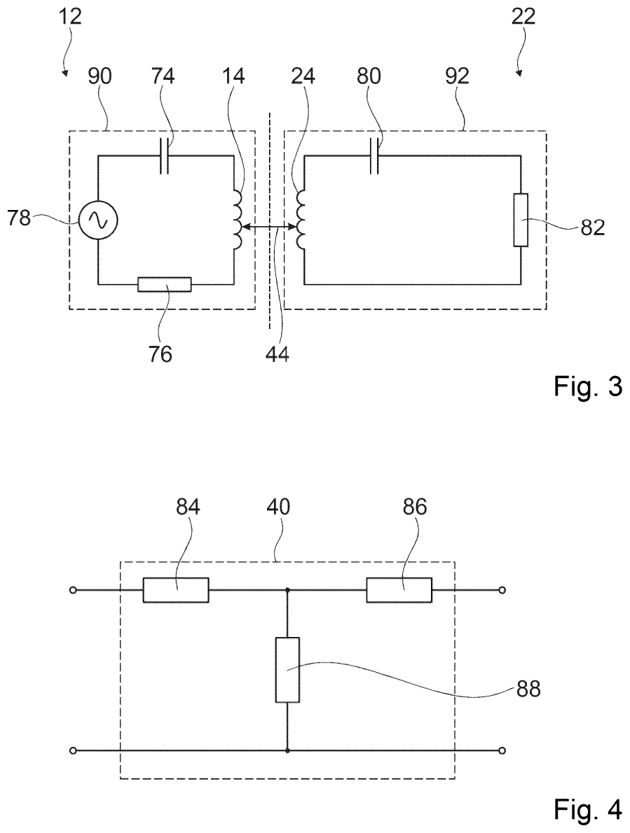

FIG. 3 shows a schematic electrical equivalent circuit diagram to illustrate an inductive energy transmission between a supply induction element of the supply unit and a receiving induction element of the positioned unit,

FIG. 4 shows a schematic electrical T-equivalent circuit diagram of the schematic electrical equivalent circuit diagram from FIG. 3,

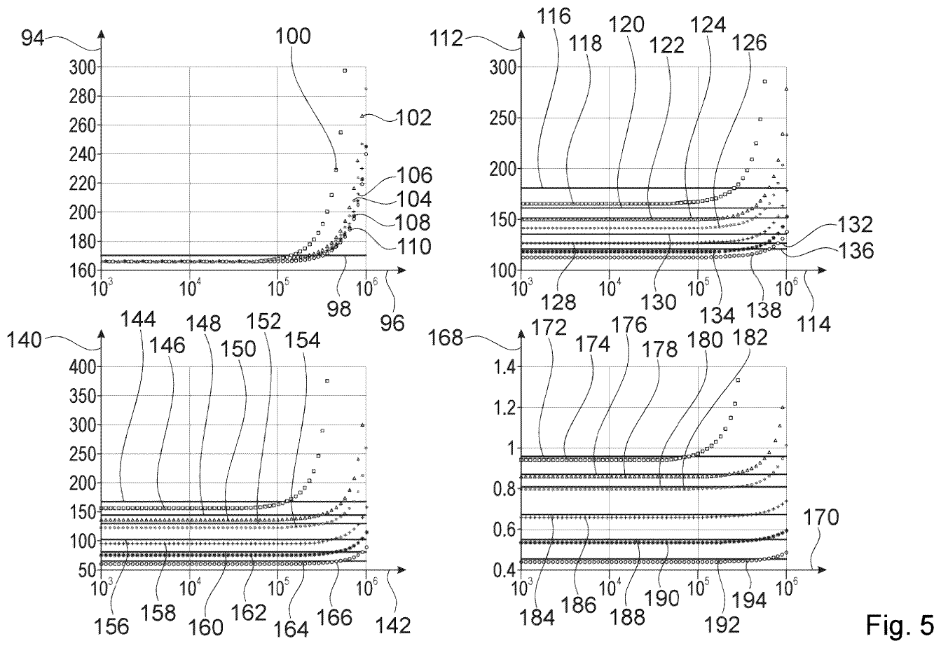

FIG. 5 shows four schematic diagrams to illustrate influencing variables on parameters of a parameter set, which uses the control unit in an operating mode for controlling the supply unit,

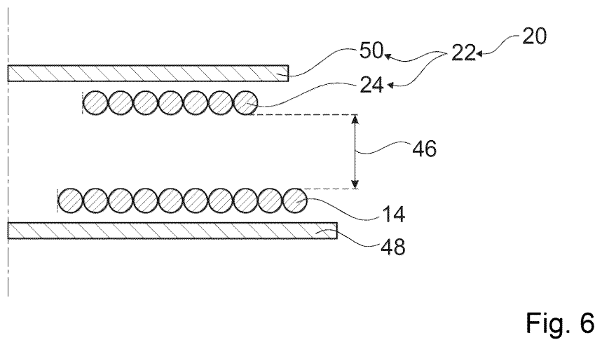

FIG. 6 shows a schematic illustration of the supply element of the supply unit and of a receiving induction element of the further positioned unit together with a magnetic flux bundling element of the supply unit and a magnetic flux bundling element of the receiving unit of the further positioned unit,

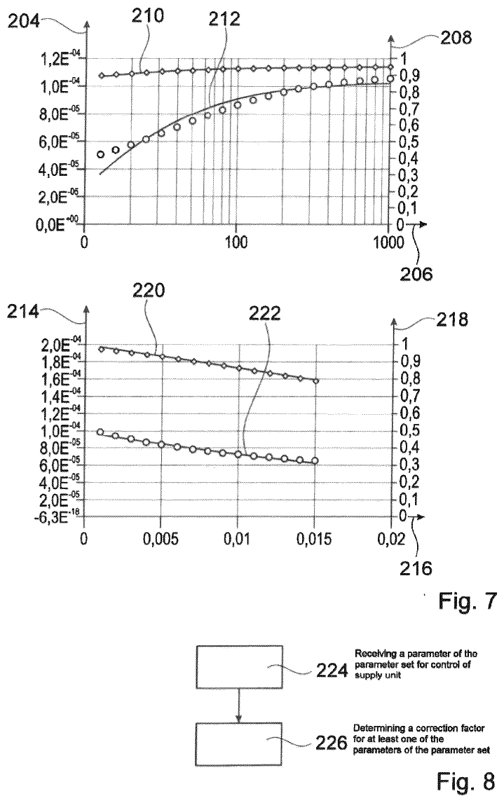

FIG. 7 shows two schematic diagrams to illustrate further influencing variables on the parameters of the parameter set and

FIG. 8 shows a schematic method flow diagram of a method for operating the induction energy transmission system.

FIG. 1 shows an induction energy transmission system 10 in a schematic illustration. The induction energy transmission system 10 has a supply unit 12. The supply unit 12 has at least one supply induction element 14 for inductively providing energy. In the present case the supply unit 12 comprises a total of four supply induction elements 14, wherein any other number would be conceivable.

The induction energy transmission system 10 has a positioned unit 18. The positioned unit 18 has a receiving unit 22 with a receiving induction element 24 for receiving the energy inductively provided by the supply unit 12. In the present case the positioned unit 18 is embodied as a small household appliance 62, namely as a food processor. The induction energy transmission system 10 in the present case has a further positioned unit 20. The further positioned unit 20 likewise comprises a receiving unit 22 with a receiving induction element 24 for receiving the energy inductively provided by the supply unit 12. The further positioned unit 20 is in the present case embodied as a further small household appliance 64, namely as a kettle.

The induction energy transmission system 10 has a control unit 16 for controlling the supply unit 12. The control unit 16 is provided to use a parameter set 36 (cf. FIG. 2) to control the supply unit 12 and to receive at least one parameter 26 (cf. FIG. 2) of the parameter set 36 from the receiving unit 22.

The induction energy transmission system 10 has a positioning plate 58 for positioning the positioned unit 18, 20.

The induction energy transmission system 10 is in the present case embodied as an induction cooking system and comprises an induction hob 60. In the present case the positioning plate 58 is embodied as a hob plate of the induction hob 60.

The induction energy transmission system 10 has a communication unit 66. The communication unit 66 is provided to transmit data wirelessly between the positioned unit 18 and the control unit 16. In the present case the communication unit 66 is also provided to transmit data wirelessly between the further positioned unit 20 and the control unit 16. The communication unit 66 has a communication element 68 which is connected to the control unit 16 and is provided to transmit and receive data wirelessly. The communication unit 66 has a further communication element 70 which is arranged in the positioned unit 18 and is provided to transmit and receive data wirelessly. The communication unit 66 also has a further communication element 72 which is arranged in the further positioned unit 20 and is provided to transmit and receive data wirelessly. In the present case the communication unit 66 is embodied as an NFC communication unit, and is provided to transmit data wirelessly by NFC between the control unit 16 and the positioned unit 18 and/or the further positioned unit 20.

FIG. 2 shows a schematic block diagram to illustrate a functionality of the control unit 16. The control unit 16 comprises a memory unit 198 and a computing unit 200. The control unit 16 further comprises an inverter unit 202 for the control and supply of energy of the supply unit 12.

In an operating mode of the induction energy transmission system 10 the control unit 16 receives the at least one parameter 26 of the positioned unit 18 wirelessly, namely via the communication element 68 of the communication unit 66, and stores it in the memory unit 198. Further parameters 28, 30 of the parameter set 36 are also stored in the memory unit 198 of the control unit 16. The parameter set 36 comprises a self-inductance 52 of the supply induction element 14. The parameter set 36 further comprises a self-inductance 54 of the receiving induction element 24. The parameter set 36 also comprises mutual inductance 56 between the supply induction element 14 and the receiving induction element 24. For example, the parameter 26 received wirelessly from the receiving unit 18 could be the self-inductance 54 of the receiving induction element 24. The further parameter 28 could for example be the self-inductance 52 of the supply induction element 14. The parameter set 36 can comprise not only the parameters 26, 28, 30 but also additional parameters (not shown), which can likewise be stored in the memory unit 198 and/or can be received wirelessly by the control unit 16 from the positioned unit 18 via the communication element 68. Further, the computing unit 200 can be provided to calculate some of the additional parameters of the parameter set 36 from other parameters, for example the parameters 26, 28, 30.

The control unit 16 is provided to determine at least one correction factor 38 for at least one parameter 26, 28, 30 of the parameter set 36. The determination of the at least one correction factor 38 is carried out by means of the computing unit 200.

The control unit 16 is provided, for the determination of the correction factor 38, to determine at least one coupling factor 32, 34, 42 between the receiving induction element 24 and the supply induction element 14.

FIG. 3 shows a simplified schematic electrical circuit diagram to illustrate an inductive energy transmission between the supply induction element 14 of the supply unit 12 and the receiving induction element 24 of the receiving unit 22 of the positioned unit 18, which are arranged at a vertical distance 44 from one another. One part of the supply unit 12 is illustrated in FIG. 3 as a primary circuit 90. The primary circuit 90 comprises not only the supply induction element 14 but also a compensation capacitor 74 and an electrical resistor 76. The primary circuit 90 also comprises an alternating voltage source 78 which is connected in series to the compensation capacitor 74, the supply induction element 14 and the electrical resistor 76. The electrical resistor 76 represents the electrical losses in operation of the primary circuit 90. At least one inverter (not shown) of the inverter unit 202 (cf. FIG. 2) can be understood as the alternating voltage source 78 in the primary circuit 90.

The receiving unit 22 of the positioned unit 18 is illustrated in FIG. 3 as a secondary circuit 92 which comprises the receiving induction element 24 and a compensation capacitor 80 connected in series thereto and an electrical resistor 82. The electrical resistor 82 represents the total electrical load in an operating mode of the positioned unit 18, which is simply assumed to be a purely ohmic load. The induction energy transmission system 10 would of course also be suitable for operation of positioned units with a total electrical load that is composed of ohmic loads and capacitive loads and/or inductive loads, since these loads can be converted by the computing unit 200 of the control unit 16 into an equivalent purely ohmic load.

The schematic electrical equivalent circuit diagram illustrated in FIG. 3 can in network theory be regarded as a two-port network. FIG. 4 shows a schematic T-equivalent circuit diagram of a two-port network of the schematic electrical equivalent circuit diagram shown in FIG. 2.

The control unit 16 is provided to use an equivalent impedance 40 between the supply unit 12 and the receiving unit 22 to determine the at least one correction factor 38. The equivalent impedance 40 in this case describes a total impedance of the primary circuit 90 and of the secondary circuit 92 of the simplified equivalent circuit diagram illustrated in FIG. 3 in an inductive energy transmission between the supply induction element 14 of the supply unit 12 and the receiving induction element 24 of the receiving unit 22. In the T-equivalent circuit diagram in FIG. 4 the equivalent impedance 40 is made up of an equivalent impedance 84 for the primary circuit 90, an equivalent impedance 86 for the secondary circuit 92 and an equivalent impedance 88 which takes into account the mutual inductance 56 (cf. FIG. 2) occurring between the supply induction element 14 and the receiving induction element 24 during the inductive energy transmission.

The inductive energy transmission between the supply induction element 14 and the receiving induction element 24 can be modeled by the computing unit 200 of the control unit 16 on the basis of the following equation system (1):

$$i . ( \begin{matrix}{Z}_{11} & {Z}_{12} \\ {Z}_{21} & {Z}_{22}\end{matrix} ) ( \begin{matrix}{I}_{1} \\ {I}_{2}\end{matrix} ) = ( \begin{matrix}V \\ 0\end{matrix} ) , \qquad ( 1 )$$

where Z₁₁ represents a self-impedance of the primary circuit 90, Z₂₂ a self-impedance of the secondary circuit 92, Z₁₂ a mutual impedance induced during the inductive energy transmission in the receiving induction element 24 by the supply induction element 14, and Z₂₁ a mutual impedance induced during the inductive energy transmission in the supply induction element 14 by the receiving induction element 24. Further, I₁ represents an alternating current flowing through the supply induction element 14 in operating mode in the primary circuit 90, 12 an alternating current flowing through the receiving induction element 24 in the secondary circuit 92 and V the alternating voltage provided by the alternating voltage source 78. Since the mutual impedances Z₁₂ and Z₂₁ have the same absolute value in the present case, the equation system (1) can be simplified to the equation system (1′) as follows:

$$ii . ( \begin{matrix}{Z}_{11} & {Z}_{12} \\ {Z}_{12} & {Z}_{22}\end{matrix} ) ( \begin{matrix}{I}_{1} \\ {I}_{2}\end{matrix} ) = ( \begin{matrix}V \\ 0\end{matrix} ) , \qquad ( {2}^{′} )$$

Further, the relationships shown in the following equations (2) to (5) apply, wherein winding losses of the supply induction element 14 and of the receiving induction element 24 as well as heat losses are ignored:

$$iii . {Z}_{11} = j ω {L}_{11} - j \frac{1}{ω {C}_{1}} , \qquad ( 3 )$$

$$iv . {Z}_{12} = j ω {L}_{12} , \qquad ( 4 )$$

$$b . {Z}_{22} = {R}_{L o a d} + j ω {L}_{22} - j \frac{1}{ω {C}_{2}} , \qquad ( 5 )$$

$$i . ω = 2 π f \qquad ( 6 )$$

In the equations (2) to (5) j stands for the imaginary unit, ω for the angular frequency, L₁₁ for the self-inductance 52 (cf. FIG. 2) of the supply induction element 14, C₁ for the capacitance of the capacitor 74 in the primary circuit 90 (cf. FIG. 3), L₂₂ for the self-inductance 54 (cf. FIG. 2) of the receiving induction element 24, L₁₂ for the mutual inductance 56 (cf. FIG. 2), R_{Load} for the electrical resistor 82 and C₂ for the capacitance of the compensation capacitor 80 in the secondary circuit 92 (cf. FIG. 3), π for the circuit constant and f for the frequency of the alternating voltage provided by the alternating voltage source 78 (cf. FIG. 3).

As explained above, the control unit 16 is provided to use the equivalent impedance 40 (cf. FIG. 4) between the supply unit 12 and the receiving unit 22 to determine the correction factor 38. The equivalent impedance 40 can be determined by the control unit 16 by measurement at the primary circuit 90. Using Kirchhoff's law, the following equation (6) can be set up for the equivalent impedance 40:

$$ii . {Z}_{e q} = \frac{V}{{I}_{1}} = {Z}_{11} - \frac{{Z}_{12}^{2}}{{Z}_{22}} . \qquad ( 6 )$$

where in equation (6) the symbol Z_{eq} stands for the equivalent impedance 40.

To calculate the at least one coupling factor 32, 34, use can be made of the simplified electrical equivalent circuit diagram shown in FIG. 3 or alternatively also the schematic T-equivalent circuit diagram, shown in FIG. 4, of the two-port network of the simplified electrical equivalent circuit diagram shown in FIG. 3. The equivalent impedance 40 in this case describes a total impedance of the primary circuit 90 and of the secondary circuit 92 of the simplified equivalent circuit diagram shown in FIG. 3 in an inductive energy transmission between the supply induction element 14 of the supply unit 12 and the receiving induction element 24 of the receiving unit 22. In FIG. 3 the equivalent impedance 84 in this case represents the difference between the self-impedance Z₁₁ of the primary circuit 90 and the mutual inductance Z₁₂, the equivalent impedance 86 represents the difference between the self-impedance Z₂₂ of the secondary circuit 92 and the mutual inductance Z₁₂, and the equivalent impedance 88 represents the mutual inductance Z₁₂, so the above equation (6) can also be derived directly from the T-equivalent circuit diagram as an alternative to using Kirchhoff's law.

Further, the equivalent impedance 40 is a complex variable and hence can also be represented in the form of the following equation (7):

$$c . {Z}_{e q} = {R}_{e q} + j ω {L}_{e q} - j \frac{1}{ω {C}_{1}} , \qquad ( 7 )$$

where Z_{eq} stands for the equivalent impedance 40, R_{eq} for an equivalent resistance (not shown) and L_{eq} for an equivalent inductance (not shown) of the schematic circuits shown in FIGS. 3 and 4.

The control unit 16 is provided to determine the equivalent resistance R_{eq} from the real part of the equivalent impedance 40. Using the equations (2), (3), (4), (6) the following equation (8) for the determination of the equivalent resistance R_{eq} can be derived from equation (7):

$$i . {R}_{eq} = \frac{{ω}^{2} {L}_{12}^{2} {R}_{load}}{{R}_{load}^{2} + {( ω {L}_{22} - \frac{1}{ω {C}_{2}} )}^{2}} , \qquad ( 8 )$$

The control unit 16 is further provided to determine the equivalent inductance L_{eq} from the imaginary part of the equivalent impedance 40. Using the equations (2), (3), (4), (6) the following equation (9) for the determination of the equivalent inductance can be derived from equation (7):

$$d . {L}_{eq} = {L}_{11} \frac{ω {L}_{12}^{2} ( ω {L}_{22} - \frac{1}{ω {C}_{2}} )}{{R}_{load}^{2} + {( ω {L}_{22} - \frac{1}{ω {C}_{2}} )}^{2}} . \qquad ( 9 )$$

The control unit 16 is provided to determine a first coupling factor 32 between the supply unit 12 and the receiving unit 22 from the equivalent resistance R_{eq}. The control unit 16 is also provided to determine a second coupling factor 34 between the supply unit 12 and the receiving unit 22 from the equivalent inductance L_{eq}. The following relationship represented in the following equation (10) exists between the self-inductance L₁₁ of the supply induction element 14, the self-inductance L₂₂ of the receiving induction element 24, the mutual inductance L₁₂ and the first coupling factor 32 or the second coupling factor 34:

$$i . {L}_{12} = k \sqrt{{L}_{11} {L}_{22}} . \qquad ( 10 )$$

where k stands generally for one of the coupling factors 32, 34. By inserting equation (10) into equation (8) and solving for k, the first coupling factor 32 can be determined by means of the following equation (11) from the equivalent resistance R_{eq}:

$$e . {k}_{{R}_{eq}} = \sqrt{\frac{{R}_{eq} ( {R}_{load}^{2} + {( ω {L}_{22} - \frac{1}{ω {C}_{2}} )}^{2} )}{{ω}^{2} {L}_{11} {L}_{22} {R}_{load}}} , \qquad ( 11 )$$

where k_{Req} stands for the first coupling factor 32. By inserting equation (10) into equation (9) and solving for k, the second coupling factor 34 can be determined by means of the following equation (12) from the equivalent inductance L_{eq}:

$$f . {k}_{{L}_{eq}} = \sqrt{\frac{( {L}_{11} - {L}_{eq} ) ( {R}_{load}^{2} + {( ω {L}_{22} - \frac{1}{ω {C}_{2}} )}^{2} )}{{ω}^{2} {L}_{11} {L}_{22} ( ω {L}_{22} - \frac{1}{ω {C}_{2}} )}} . \qquad ( 12 )$$

where k_{Leq} stands for the second coupling factor 34.

The control unit 16 is provided to determine the correction factor 38 from a comparison between the first coupling factor 32 and the second coupling factor 34. As can be seen from equation (11), the coupling factors 32, 34 create a relationship between the self-inductance L₁₁ of the supply induction element 14, the self-inductance L₂₂ of the receiving induction element 24 and the mutual inductance L₁₂. In general the coupling factors 32, 34 describe a portion of a magnetic flux that is shared by the supply induction element 14 and the receiving induction element 24 in operating mode. The coupling factors 32, 34 can assume values between 0 and 1, wherein a value of 1 would represent an ideal magnetic coupling. However, in practice magnetic leakage losses occur, so that the values of the coupling factor 32, 34 are less than 1. In theory, the first coupling factor 32, which can be determined from equation (12), and the second coupling factor 34, which can be determined from equation (13), should assume identical values for all frequencies f of the alternating voltage provided by the alternating voltage source 78. However, studies by the applicant have shown that the first coupling factor 32 and the second coupling factor 34 deviate from one another in practice. The present invention takes advantage of this fact, in that in operating mode the control unit 16 compares the first coupling factor 32 with the second coupling factor 34 in order to determine the at least one correction factor 38. Studies by the applicant have shown that the first coupling factor 32 changes only slightly with changes to the self-inductance 52 of the supply induction element 14, the self-inductance 54 of the receiving induction element 24 and the mutual inductance 56, whereas the second coupling factor 34 exhibits a greater variance with the same changes. If the second coupling factor 34 determined by the control unit 16 in operating mode is greater than the determined first coupling factor 32, the control unit 16 draws the conclusion that the values, stored in the memory unit 198, of the self-inductance 52 of the supply induction element 14, the self-inductance 54 of the receiving induction element 24 and the mutual inductance 56 are too high and the control unit 16 corrects these parameters of the parameter set 36 downward by means of the at least one correction factor 38. If the second coupling factor 34 determined by the control unit 16 in operating mode is smaller than the determined first coupling factor 32 the control unit 16 draws the conclusion that the values, stored in the memory unit 198, of the self-inductance 52 of the supply induction element 14, the self-inductance 54 of the receiving induction element 24 and the mutual inductance 56 are too low and the control unit 16 corrects these parameters of the parameter set 36 upward by means of the at least one correction factor 38. For example, different values for the at least one correction factor 38 in relation to a difference between the first coupling factor 32 and the second coupling factor 34 can be stored in the memory unit 198. Alternatively or additionally, an algorithm that can be executed by the computing unit 200 can also be stored in the memory unit 198 of the control unit 16, and by means of said algorithm relatively precise estimated values of the self-inductance 52 of the supply induction element 14, the self-inductance 54 of the receiving induction element 24 and the mutual inductance 56 can be derived from the first coupling factor 32 and the second coupling factor 34, for example by means of numeric methods. It is also conceivable for the control unit 16 to vary the values of the at least one correction factor 38 until the values of the first coupling factor 32 and of the second coupling factor 34 approximate one another sufficiently precisely.

The control unit 16 is further provided to use at least one transformer equation to calculate the at least one coupling factor 42. The calculation of the coupling factor 42 can alternatively or additionally be carried out to calculate the first coupling factor 32 and the second coupling factor 34. To this end the supply induction element 14 can be regarded as a primary side of a transformer and the receiving induction element 14 as a secondary side of the transformer. A first transformer equation (13) for the primary side is, in differential form:

$$i . {V}_{p} = {L}_{p} \frac{{dI}_{p}}{dt} + {M}_{ps} \frac{{dI}_{s}}{dt} \qquad ( 13 )$$

where V_{P} stands for the alternating voltage provided in operating mode by the alternating voltage source 78, L_{P} for the self-inductance 52 of the supply induction element 14, I_{P} for an alternating current flowing in operating mode through the supply induction element 14, M_{PS} for the mutual inductance 56 between the supply induction element 14 and the receiving induction element 24, I_{S} for an alternating current flowing in operating mode through the receiving induction element 24 and t for the time.

A second transformer equation (14) for the secondary side is, in differential form:

$$g . 0 = {L}_{s} \frac{{dI}_{s}}{dt} + {M}_{ps} \frac{{dI}_{p}}{dt} + Z {I}_{s} \qquad ( 14 )$$

where L_{S} stands for the self-inductance 54 of the receiving induction element 24 and Z for an equivalent impedance from the electrical resistor 82 and the compensation capacitor 80 of the secondary circuit 92 (cf. FIG. 3). The following equation (15) applies for the equivalent impedance Z:

$$i \text{.0} = {R}_{s} + \frac{1}{{C}_{s} s} \qquad ( 15 )$$

where R_{S} stands for the value of the electrical resistor 82, C_{S} for the capacitance of the compensation capacitor 80 and s for a complex frequency parameter for a Laplace transformation. The following equation (16) applies for the complex frequency parameter s:

$$ii . s = j ω = j 2 π f \qquad ( 16 )$$

where j stands for the imaginary unit, ω for the angular frequency, π for the circuit constant and f for the frequency of the alternating voltage provided by the alternating voltage source 78 (cf. FIG. 3). Further, the resonance frequency ωᵣ is determined in accordance with the following equation (17):

$$iii . {ω}_{r} = \frac{1}{\sqrt{{L}_{p} {L}_{s}}} \qquad ( 17 )$$

Moreover, the time constant T_{S} can be introduced in accordance with equation (18):

$$1. {τ}_{s} = \frac{{L}_{s}}{{R}_{s}} \qquad ( 18 )$$

Analogously to the above equation (19), the following equation (19) applies for the coupling factor 42:

$$iv . k = \frac{{M}_{ps}}{\sqrt{{L}_{p} {L}_{s}}} \qquad ( 19 )$$

where k stands for the coupling factor 42.

An equivalent impedance Z_{P} for the primary side can be determined using the following equation (20):

$$h . {Z}_{p} = {L}_{p} s \frac{( {τ}_{s} - {k}^{2} {τ}_{s} ) {s}^{2} + s + {τ}_{s} {ω}_{r}^{2}}{{τ}_{s} {s}^{2} + s + {τ}_{s} {ω}_{r}^{2}} \qquad ( 20 )$$

An equivalent resistance R_{eq} can be calculated as follows by means of the following equation (21):

$$i . {R}_{eq} = \frac{{L}_{p} {τ}_{s} {k}^{2} {ω}^{2}}{{τ}_{s}^{2} {ω}^{4} - 2 {τ}_{s}^{2} {ω}^{2} {ω}_{r}^{2} + {τ}_{s}^{2} {ω}_{r}^{2} + {ω}^{2}} \qquad ( 21 )$$

The coupling factor 42 can be determined by the control unit 16 from equation (22) using the equations (13) to (21) as follows:

$$j . k = \sqrt{\frac{{R}_{eq} ( {τ}_{s}^{2} {ω}^{4} - 2 {τ}_{s}^{2} {ω}^{2} {ω}_{r}^{2} + {τ}_{s}^{2} {ω}_{r}^{2} + {ω}^{2}}{{L}_{p} {τ}_{s} {ω}^{4}}} \qquad ( 22 )$$

The determination of the coupling factor 42 can also be used by the control unit 16 for example to control the supply unit 12 for inductively providing energy to the receiving unit 22 of the further positioned unit 20 (cf. FIG. 1).

FIG. 5 shows four schematic diagrams to illustrate theoretical values and measured values of the self-inductance 52 of the supply induction element 14, the self-inductance 54 of the receiving induction element 24, the mutual inductance 56 between the supply induction element 14 and the receiving induction element 24 and coupling factors determined from the theoretical values and the measured values.

An inductance is plotted in microhenries on an ordinate 94 of an upper-left diagram in FIG. 5. The frequency f of the alternating voltage provided by the alternating voltage source 78 is plotted in hertz on an abscissa 96 of the upper-left diagram. A straight line 98 shows the theoretical value of the self-inductance 52 of the supply induction element 14, which in theory should be constant across the whole frequency range. However, as from a frequency of approximately 10⁵ hertz considerable deviations occur in practice for measured values of the self-inductance 52 of the supply induction element 14, which among other things can also vary as a function of a vertical distance 44 (cf. FIG. 3) between the supply induction element 14 and the receiving induction element 24. A first measured curve 100 in the upper-left diagram shows measured values of the self-inductance 52 for a vertical distance 44 of 0.7 millimeters. A second measured curve 102 in the upper-left diagram shows measured values of the self-inductance 52 for a vertical distance 44 of 6.6 millimeters. A third measured curve 104 in the upper-left diagram shows measured values of the self-inductance 52 for a vertical distance 44 of 10.8 millimeters. A fourth measured curve 106 in the upper-left diagram shows measured values of the self-inductance 52 for a vertical distance 44 of 20.8 millimeters. A fifth measured curve 108 in the upper-left diagram shows measured values of the self-inductance 52 for a vertical distance 44 of 30.9 millimeters. A sixth measured curve 110 in the upper-left diagram shows measured values of the self-inductance 52 for a vertical distance 44 of 40.7 millimeters.

An inductance is plotted in microhenries on an ordinate 112 of an upper-right diagram in FIG. 5. The frequency f of the alternating voltage provided by the alternating voltage source 78 is plotted in hertz on an abscissa 114 of the upper-right diagram. A first straight line 116 shows the theoretical value of the self-inductance 54 of the receiving induction element 24 for a vertical distance 44 of 0.7 millimeters, which in theory should be constant across the whole frequency range. However, as from a frequency of approximately 105 hertz considerable deviations also occur in practice for the self-inductance 54 of the receiving induction element 24 for measured values of the self-inductance 54 of the receiving induction element 24, which are shown in a first measured curve 118 in the bottom-left diagram. A second straight line 120 shows the theoretical value of the self-inductance 54 of the receiving induction element 24 for a vertical distance 44 of 6.6 millimeters, wherein a second measured curve 122 for the vertical distance 44 of 6.6 millimeters deviates from the second straight line 120 as the frequency increases in the range between 10⁵ hertz and 10⁶ hertz. A third straight line 124 shows the theoretical value of the self-inductance 54 of the receiving induction element 24 for a vertical distance 44 of 10.8 millimeters, wherein a third measured curve 126 for the vertical distance 44 of 10.8 millimeters deviates from the third straight line 124 as the frequency increases in the range between 10⁵ hertz and 10⁶ hertz. A fourth straight line 128 shows the theoretical value of the self-inductance 54 of the receiving induction element 24 for a vertical distance 44 of 20.8 millimeters, wherein a fourth measured curve 130 for the vertical distance 44 of 20.8 millimeters deviates from the fourth straight line 128 as the frequency increases in the range between 10⁵ hertz and 10⁶ hertz. A fifth straight line 132 shows the theoretical value of the self-inductance 54 of the receiving induction element 24 for a vertical distance 44 of 30.9 millimeters, wherein a fifth measured curve 134 for the vertical distance 44 of 30.9 millimeters deviates from the fifth straight line 132 as the frequency increases in the range between 10⁵ hertz and 10⁶ hertz. A sixth straight line 136 shows the theoretical value of the self-inductance 54 of the receiving induction element 24 for a vertical distance 44 of 40.7 millimeters, wherein a sixth measured curve 138 for the vertical distance 44 of 40.7 millimeters deviates from the sixth straight line 136 as the frequency increases in the range between 10⁵ hertz and 10⁶ hertz.

An inductance is plotted in microhenries on an ordinate 140 of a bottom-left diagram in FIG. 5. The frequency f of the alternating voltage provided by the alternating voltage source 78 is plotted in hertz on an abscissa 142 of the upper-left diagram. A first straight line 144 shows a theoretical value of the mutual inductance 56 between supply induction element 14 and the receiving induction element 24 for a vertical distance 44 of 0.7 millimeters, which in theory should be constant across the whole frequency range. However, as from a frequency of approximately 10⁵ hertz considerable deviations also occur in practice for the mutual inductance 56, which are represented in a first measured curve 146 in the bottom-left diagram. A second straight line 148 shows the theoretical value of the mutual inductance 56 for a vertical distance 44 of 6.6 millimeters, wherein a second measured curve 150 for the vertical distance 44 of 6.6 millimeters deviates from the second straight line 148 as the frequency increases in the range between 10⁵ hertz and 10⁶ hertz. A third straight line 152 shows the theoretical value of the mutual inductance 56 for a vertical distance 44 of 6.6 millimeters, wherein a third measured curve 154 for the vertical distance 44 of 6.6 millimeters deviates from the second straight line 148 as the frequency increases in the range between 10⁵ hertz and 10⁶ hertz. A fourth straight line 156 shows the theoretical value of the mutual inductance 56 for a vertical distance 44 of 20.8 millimeters, wherein a fourth measured curve 158 for the vertical distance 44 of 20.8 millimeters deviates from the fourth straight line 156 as the frequency increases in the range between 10⁵ hertz and 10⁶ hertz. A fifth straight line 160 shows the theoretical value of the mutual inductance 56 for a vertical distance 44 of 30.9 millimeters, wherein a fifth measured curve 162 for the vertical distance 44 of 30.9 millimeters deviates from the fifth straight line 160 as the frequency increases in the range between 10⁵ hertz and 10⁶ hertz. A sixth straight line 164 shows the theoretical value of the mutual inductance 56 for a vertical distance 44 of 40.7 millimeters, wherein a sixth measured curve 166 for the vertical distance 44 of 40.7 millimeters deviates from the sixth straight line 164 as the frequency increases in the range between 10⁵ hertz and 10⁶ hertz.

A dimensionless coupling factor is plotted on an ordinate 168 of a bottom-right diagram in FIG. 5. The frequency f of the alternating voltage provided by the alternating voltage source 78 is plotted in hertz on an abscissa 142 of the bottom-right diagram. A first straight line 172 in the bottom-right diagram shows a theoretical coupling factor between the supply induction element 14 and the receiving induction element 24 with a vertical distance 44 of 0.7 millimeters, which is constant across the whole frequency range. A first curve 174 shows calculated values for a calculated coupling factor from the measured values for the self-inductance 52 of the supply induction element 14, the self-inductance 54 of the receiving induction element 24 and the mutual inductance 56 for a distance 44 of 0.7 millimeters. A second straight line 176 in the bottom-right diagram shows a theoretical coupling factor between the supply induction element 14 and the receiving induction element 24 with a vertical distance 44 of 6.6 millimeters, which is constant across the whole frequency range. A second curve 178 shows calculated values for a calculated coupling factor from the measured values for the self-inductance 52 of the supply induction element 14, the self-inductance 54 of the receiving induction element 24 and the mutual inductance 56 for a vertical distance 44 of 6.6 millimeters. A third straight line 180 in the bottom-right diagram shows a theoretical coupling factor between the supply induction element 14 and the receiving induction element 24 with a vertical distance 44 of 10.8 millimeters, which is constant across the whole frequency range. A third curve 182 shows calculated values for a calculated coupling factor from the measured values for the self-inductance 52 of the supply induction element 14, the self-inductance 54 of the receiving induction element 24 and the mutual inductance 56 for a vertical distance 44 of 10.8 millimeters. A fourth straight line 184 in the bottom-right diagram shows a theoretical coupling factor between the supply induction element 14 and the receiving induction element 24 with a vertical distance 44 of 20.8 millimeters, which is constant across the whole frequency range. A fourth curve 186 shows calculated values for a calculated coupling factor from the measured values for the self-inductance 52 of the supply induction element 14, the self-inductance 54 of the receiving induction element 24 and the mutual inductance 56 for a vertical distance 44 of 20.8 millimeters. A fifth straight line 188 in the bottom-right diagram shows a theoretical coupling factor between the supply induction element 14 and the receiving induction element 24 with a vertical distance 44 of 30.9 millimeters, which is constant across the whole frequency range. A fifth curve 190 shows calculated values for a calculated coupling factor from the measured values for the self-inductance 52 of the supply induction element 14, the self-inductance 54 of the receiving induction element 24 and the mutual inductance 56 for a vertical distance 44 of 30.9 millimeters. A sixth straight line 192 in the bottom-right diagram shows a theoretical coupling factor between the supply induction element 14 and the receiving induction element 24 with a vertical distance 44 of 40.7 millimeters, which is constant across the whole frequency range. A sixth curve 194 shows calculated values for a calculated coupling factor from the measured values for the self-inductance 52 of the supply induction element 14, the self-inductance 54 of the receiving induction element 24 and the mutual inductance 56 for a vertical distance 44 of 40.7 millimeters.

FIG. 6 shows a schematic illustration of the supply element 14 and of the receiving induction element 24 of the receiving unit 22 of the further positioned unit 20 together with a magnetic flux bundling element 48 of the supply unit 12 and a magnetic flux bundling element 50 of the receiving unit 22. FIG. 6 shows a vertical distance 46 between the supply induction element 14 and the receiving induction element 24. The control unit 16 is provided, in the determination of the correction factor 38, to take into account the vertical distance 44 between the supply induction element 14 and the receiving induction element 24. Different measured values for coupling factors 32, 34, 42 for different vertical distances 44 between the supply induction element 14 and the receiving induction element 24, for example the measured values and/or further measured values shown in FIG. 5, can be stored in the memory unit 198 of the control unit 16.

The control unit 16 is provided, in the determination of the correction factor 38, to take into account a magnetic permeability (not shown) of the magnetic flux bundling element 48 of the supply unit 12 and/or of the magnetic flux bundling element 50 of the receiving unit 22.

FIG. 7 shows two schematic diagrams to illustrate influencing variables on the parameters 26, 28, 30 of the parameter set 36, which were determined by the applicant as part of a series of measurements. An inductance is plotted in henries on a left-hand ordinate 204 of an upper diagram in FIG. 7. A dimensionless magnetic permeability is plotted on an abscissa 206 of the upper diagram. The dimensionless coupling factor 42 is plotted on a right-hand ordinate 208 of the upper diagram. A first curve 210 shows a characteristic of the coupling factor 42 as a function of magnetic permeability. A second curve 212 shows a characteristic of the self-inductance 52 of the supply induction element 14 and a self-inductance (not shown) of the receiving induction element 24 of the receiving unit 22 of the further positioned unit 20 as a function of magnetic permeability, wherein the self-inductance 52 of the supply induction element 14 and the self-inductance of the receiving induction element 24 have the same values in the present case.

An inductance in henries is plotted on a left-hand ordinate 214 of a lower diagram in FIG. 7. The vertical distance 46 is plotted in meters on an abscissa 216 of the lower diagram. The dimensionless coupling factor 42 is plotted on a right-hand ordinate 218 of the lower diagram. A first curve 220 in the right-hand diagram shows a characteristic of the coupling factor 42 as a function of the vertical distance 46. A second curve 222 in the right-hand diagram shows a characteristic of the self-inductance 52 of the supply induction element 14 and the self-inductance of the receiving induction element 24 of the receiving unit 22 of the further positioned unit 20 as a function of the distance 46.

The series of measurements shown in FIG. 7 of the magnetic permeability and of the vertical distances 46 as influencing variables on the inductive energy transmission can be stored in the memory unit 198 and can be taken into account by the control unit 16 in the determination of the at least one correction factor 38, for example in combination with the determined coupling factor 42.

FIG. 8 shows a schematic method flow diagram of a method for operating the induction energy transmission system 10. The method comprises at least two method steps 224, 226. In a first method step 224 of the method at least one parameter 26 of the parameter set 36 is received from the positioned unit 18 and/or the further positioned unit 20 and the parameter set 36 is used to control the supply unit 12. In a second method step 226 of the method the at least one correction factor 38 is determined for at least one of the parameters 26, 28, 30 of the parameter set 36.

### REFERENCE CHARACTERS

10 Induction energy transmission system
12 Supply unit
14 Supply induction element
16 Control unit
18 Positioned unit
20 Further positioned unit
22 Receiving unit
24 Receiving induction element
26 Parameter
28 Further parameter
30 Further parameter
32 First coupling factor
34 Second coupling factor
36 Parameter set
38 Correction factor
40 Equivalent impedance
42 Coupling factor
44 Vertical distance
46 Vertical distance
48 Magnetic flux bundling element
50 Magnetic flux bundling element
52 Self-inductance
54 Self-inductance
56 Mutual inductance
58 Positioning plate
60 Induction hob
62 Small household appliance
64 Further small household appliance
66 Communication unit
68 Communication element
70 Further communication element
72 Further communication element
74 Compensation capacitor
76 Electrical resistor
78 Alternating voltage source
80 Compensation capacitor
82 Electrical resistor
84 Equivalent impedance
86 Equivalent impedance
88 Equivalent impedance
90 Primary circuit
92 Secondary circuit
94 Ordinate
96 Abscissa
98 Straight line
100 First measured curve
102 Second measured curve
104 Third measured curve
106 Fourth measured curve
108 Fifth measured curve
110 Sixth measured curve
112 Ordinate
114 Abscissa
116 First straight line
118 First measured curve
120 Second straight line
122 Second measured curve
124 Third straight line
126 Third measured curve
128 Fourth straight line
130 Fourth measured curve
132 Fifth straight line
134 Fifth measured curve
136 Sixth straight line
138 Sixth measured curve
140 Ordinate
142 Abscissa
144 First straight line
146 First measured curve
148 Second straight line
150 Second measured curve
152 Third straight line
154 Third measured curve
156 Fourth straight line
158 Fourth measured curve
160 Fifth straight line
162 Fifth measured curve
164 Sixth straight line
166 Sixth measured curve
168 Ordinate
170 Abscissa
172 First straight line
174 First curve
176 Second straight line
178 Second curve
180 Third straight line
182 Third curve
184 Fourth straight line
186 Fourth curve
188 Fifth straight line
190 Fifth curve
192 Sixth straight line
194 Sixth curve
198 Memory unit
200 Computing unit
202 Inverter unit
204 Left-hand ordinate
206 Abscissa
208 Right-hand ordinate
210 First curve
212 Second curve
214 Left-hand ordinate
216 Abscissa
218 Right-hand ordinate
220 First curve
222 Second curve
224 First method step
226 Second method step

1-15. (canceled)

16. An induction energy transmission system, in particular an induction cooking system, said induction energy transmission system comprising:
a supply unit comprising a supply induction element for inductively providing energy;
a positioned unit comprising a receiving unit which includes a receiving induction element for receiving the inductively provided energy; and
a control unit designed to control the supply unit by using a parameter set comprising a plurality of parameters and to receive at least one of the parameters of the parameter set from the positioned unit, said control unit being designed to determine a correction factor for at least one of the parameters of the parameter set.

17. The induction energy transmission system of claim 16, wherein the control unit is designed to determine a coupling factor between the receiving induction element and the supply induction element for determination of the correction factor.

18. The induction energy transmission system of claim 16, wherein the control unit is designed to use an equivalent impedance between the supply unit and the receiving unit for determination of the correction factor.

19. The induction energy transmission system of claim 18, wherein the control unit is designed to determine an equivalent resistance from a real part of the equivalent impedance.

20. The induction energy transmission system of claim 18, wherein the control unit is designed to determine an equivalent inductance from an imaginary part of the equivalent impedance.

21. The induction energy transmission system of claim 19, wherein the control unit is designed to determine a first coupling factor between the supply unit and the receiving unit from the equivalent resistance.

22. The induction energy transmission system of claim 21, wherein the control unit is designed to determine an equivalent inductance from an imaginary part of the equivalent impedance and to determine a second coupling factor between the supply unit and the receiving unit from the equivalent inductance.

23. The induction energy transmission system of claim 22, wherein the control unit is designed to determine the correction factor from a comparison between the first coupling factor and the second coupling factor.

24. The induction energy transmission system of claim 17, wherein the control unit is designed to use a transformer equation for calculation of the coupling factor.

25. The induction energy transmission system of claim 16, wherein the control unit is designed to take into account a vertical distance between the supply induction element and the receiving induction element when determining the correction factor.

26. The induction energy transmission system of claim 16, wherein the control unit is designed to take into account a magnetic permeability of a magnetic flux bundling element of the supply unit and/or receiving unit when determining the correction factor.

27. The induction energy transmission system of claim 16, wherein the parameter set comprises a self-inductance of the supply induction element.

28. The induction energy transmission system of claim 16, wherein the parameter set comprises a self-inductance of the receiving induction element.

29. The induction energy transmission system of claim 16, wherein the parameter set comprises a mutual inductance between the supply induction element and the receiving induction element.

30. A method for operating an induction energy transmission system, said method comprising:
controlling a supply unit for inductively providing energy to a positioned unit by using at least one of a plurality of parameters of a parameter set received from the positioned unit; and
determining a correction factor for at least one of the parameters of the parameter set.

31. The method of claim 30, further comprising determining a coupling factor between a receiving induction element of a receiving unit of the positioned unit and a supply induction element of the supply unit for determination of the correction factor.

32. The method of claim 30, further comprising using an equivalent impedance between the supply unit and a receiving unit of the positioned unit for determination of the correction factor.

33. The method of claim 32, further comprising determining an equivalent resistance from a real part of the equivalent impedance.

34. The method of claim 32, further comprising determining an equivalent inductance from an imaginary part of the equivalent impedance.

35. The method of claim 33, further comprising determining a first coupling factor between the supply unit and the receiving unit from the equivalent resistance.

36. The method of claim 35, further comprising:
determining an equivalent inductance from an imaginary part of the equivalent impedance; and
determining a second coupling factor between the supply unit and the receiving unit from the equivalent inductance.

37. The method of claim 36, further comprising determining the correction factor from a comparison between the first coupling factor and the second coupling factor.

38. The method of claim 31, further comprising using a transformer equation for calculation of the coupling factor.

39. The method of claim 31, further comprising taking into account a vertical distance between the supply induction element and the receiving induction element when determining the correction factor.

40. The method of claim 30, further comprising taking into account a magnetic permeability of a magnetic flux bundling element of the supply unit and/or a receiving unit of the positioned unit when determining the correction factor.
